(19) United States
(12) Patent Application Publication
(10) Pub. No.: US 2016/0061959 A1
(43) Pub. Date: Mar. 3, 2016

(54) POSITIONING METHOD FOR A POSITIONING DEVICE OF A SATELLITE POSITIONING SYSTEM AND POSITIONING DEVICE

(71) Applicant: INTERNATIONAL BUSINESS MACHINES CORPORATION, Armonk, NY (US)

(72) Inventors: Jie JM MAN, Beijing (CN); Jian Hui SI, Beijing (CN); Dong WANG, Beijing (CN); Cong Yue YANG, Beijing (CN)

(21) Appl. No.: 14/805,822

(22) Filed: Jul. 22, 2015

(30) Foreign Application Priority Data
Aug. 28, 2014 (CN) 2014-10430987.0

(51) Int. Cl. G01S 19/24; G01S 19/30; G01S 19/29

(52) U.S. Cl. CPC G01S 19/24; G01S 19/29; G01S 19/30

(57) ABSTRACT

A positioning device and a positioning method are provided for a satellite positioning system. The positioning device for the satellite positioning system includes: a Radio Frequency (RF) signal processor configured to perform processing on received RF signals transmitted by satellites, to obtain corresponding Intermediate Frequency (IF) signals and feed the IF signals to a capturer; a capturer configured to perform baseband processing on the received IF signals to capture parameters for tracking the satellites, and feed the parameters to a tracker and a sharer; a tracker configured to perform satellite tracking by utilizing the captured parameters for tracking the satellites; and a sharer configured to share the parameters for tracking the satellites with another positioning device.

### PRIOR FOREIGN APPLICATION

This application claims priority from Chinese (CN) patent application number 201410430987.0, filed Aug. 28, 2014, which is hereby incorporated herein by reference in its entirety.

### BACKGROUND

The present invention relates generally to a satellite positioning system. And more specifically, the present invention relates to a positioning method for a positioning device of a satellite positioning system and to a positioning device.

Satellite positioning systems are widely used in various aspects of production and living. Nowadays, satellite positioning system in the world includes Global Positioning System (GPS), Global Navigation Satellite System (GLONASS), Galileo satellite navigation and positioning system, etc. They all have similar composition structure, which includes a space portion having satellites at a low earth running orbit, a control portion and a user portion on the ground. Taking Global Positioning System (GPS) for example, the space portion includes 21 GPS satellites for navigation and 3 active spare satellites. These 24 satellites circle the Earth and are distributed in 6 orbits where an angle between each other is 60 degree. The user portion, namely a positioning device, includes a GPS receiver, data processing software and corresponding user equipment.

According to design of the satellite positioning system, a positioning device must lock onto a certain number of satellites to be able to perform positioning. In case there are constraints in surrounding environment, such as there is a tall building or a tree that obstructs the satellite signal or the positioning device is located within a building, usually it is unable to search and lock onto enough satellites, and thus cannot achieve the objective of being able to perform positioning.

### SUMMARY

According to one aspect of the present invention, there is disclosed a positioning device for a satellite positioning system, comprising: a Radio Frequency (RF) signal processor configured to process received RF signals transmitted by satellites, to obtain corresponding Intermediate Frequency (IF) signals and feed the IF signals to a capturer; a capturer configured to perform baseband processing on the received IF signals to capture parameters for tracking the satellites, and feed the parameters to a tracker and a sharer; a tracker configured to perform satellite tracking by utilizing the captured parameters for tracking the satellites; and a sharer configured to share the parameters for tracking the satellites with another positioning device.

According to another aspect of the present invention, a positioning method for a positioning device of a satellite positioning system is disclosed, which includes: performing processing on received Radio Frequency (RF) signals transmitted by satellites to obtain corresponding Intermediate Frequency (IF) signals; performing baseband processing on the IF signals to capture parameters for tracking the satellites; performing satellite tracking by utilizing the captured parameters for tracking the satellites; and sharing the parameters for tracking the satellites with another positioning device.

According to a further aspect of the present invention, a computer program product for a positioning device of a satellite positioning system is provided. The computer program product includes a computer-readable storage medium having program instructions embodied therein, the program instructing being executable by a computer to cause the computer to: perform processing on received Radio Frequency (RF) signals transmitted by satellites to obtain corresponding Intermediate Frequency (IF) signals; perform baseband processing on the IF signals to capture parameters for tracking the satellites; perform satellite tracking by utilizing the captured parameters for tracking the satellites; and share the parameters for tracking the satellites with another positioning device.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a structural block diagram of a positioning device 100 of a satellite positioning system;

FIG. 2 shows a structural block diagram of a positioning device 200 of a satellite positioning system according to one or more aspects of the present invention;

FIG. 3 shows a structural block diagram of another positioning device 300 of a satellite positioning system according to one or more aspects of the present invention;

FIG. 4 shows a flowchart of a positioning method 400 for a satellite positioning system according to one or more aspects of the present invention; and

FIG. 5 shows a flowchart of another positioning method 500 for a satellite positioning system according to one or more aspects of the present invention.

### DETAILED DESCRIPTION

One or more aspects of the present invention are described in detail below with reference to the accompanying drawings, in which certain embodiments of the present disclosure are illustrated. However, the present disclosure can be implemented in various manners, and thus should not be construed to be limited to the embodiments disclosed herein. On the contrary, the depicted embodiments are provided for understanding of certain aspects of the present disclosure, and to convey examples of the present disclosure to those skilled in the art.

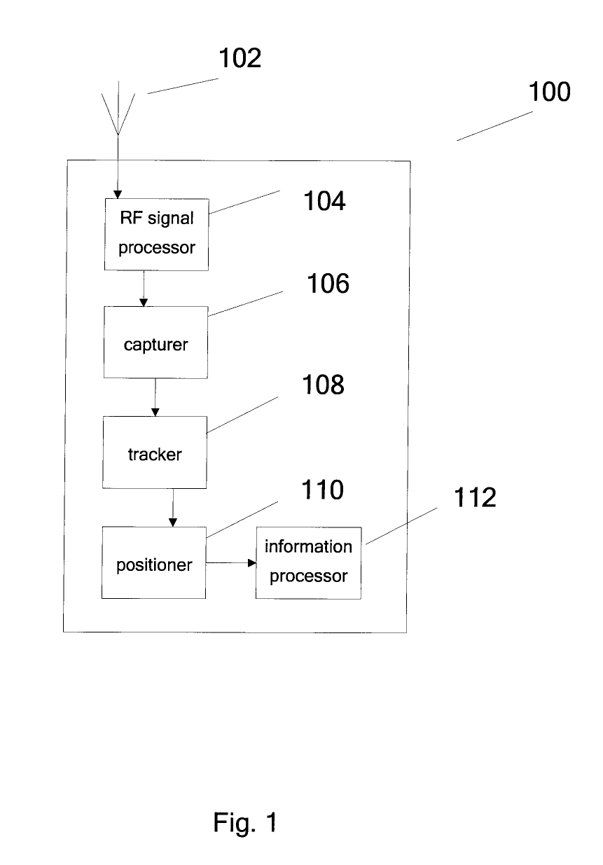

FIG. 1 shows a structural block diagram of a positioning device 100 of a satellite positioning system. As shown in FIG. 1, the positioning device 100 of the satellite positioning system includes an antenna 102 for receiving Radio Frequency (RF) signals transmitted by satellites. The RF signals received by the antenna 102 are fed to a RF signal processor 104 and processed therein to obtain corresponding Intermediate Frequency (IF) signals. Then, the IF signals are fed to a capturer 106, and baseband processing is performed therein to obtain parameters for tracking the satellites. And then, the parameters for tracking the satellites are fed to a tracker 108 for performing satellite tracking When the tracker 108 has successfully tracked the satellites, navigation data of the satellites is obtained and fed to a positioner 110, and processing is performed therein to obtain position, velocity and time (PVT) of the positioning device, etc. The output of the positioner 110 is fed to an information processor 112, and further processing is performed therein to be used for expected services such as navigation, positioning, computing, etc.

Taking a positioning device of GPS for example, L1 C/A code RF signals transmitted by GPS satellites with a frequency of 1575.42 MHz are received by an antenna and fed to a RF signal processor. In the RF signal processor, by performing processing (maybe multiple times) such as mixing, filtering, amplification and the like on the L1 C/A code RF signals with inputted frequency of 1575.42 MHz and local frequency, corresponding IF signals (the IF signals may be signal with a frequency of 1.405 MHz) are obtained and fed to a capturer for performing baseband processing to capture parameters for tracking the satellites. For the GPS is a Code Division Multiple Access (CDMA) satellite positioning system, the parameters for tracking the satellites, which are obtained after baseband processing of the capturer, are a code phase of satellite encoding and an IF corresponding to the satellite encoding of the GPS satellites. Thereafter, the code phase of satellite encoding and the IF corresponding to the satellite encoding are fed to the tracker, so as to utilize these parameters to track the satellites. After the tracker has successfully tracked the satellites, it starts to receive navigation data from locked satellites and feed the navigation data to the positioner to be used for performing positioning and other related processing.

As described above, according to design of an existing satellite positioning system, a positioning device must lock onto a certain number of satellites to be able to perform positioning. In case there are constraints in surrounding environment, such as there is a tall building or a tree that obstructs the satellite signal or the positioning device is located within a building, usually it is unable to search and lock onto enough satellites, thus cannot achieve the objective of being able to perform positioning. The present invention has taken the above mentioned problem into consideration and sets forth a technical solution that can solve the above technical problem.

With the positioning devices and positioning methods disclosed herein, the positioning devices are capable of sharing captured parameters for tracking satellites, with another positioning device located nearby being enabled to receive the parameters for tracking the satellites therefrom to perform tracking of the satellites, which effectively solves the above-noted problem.

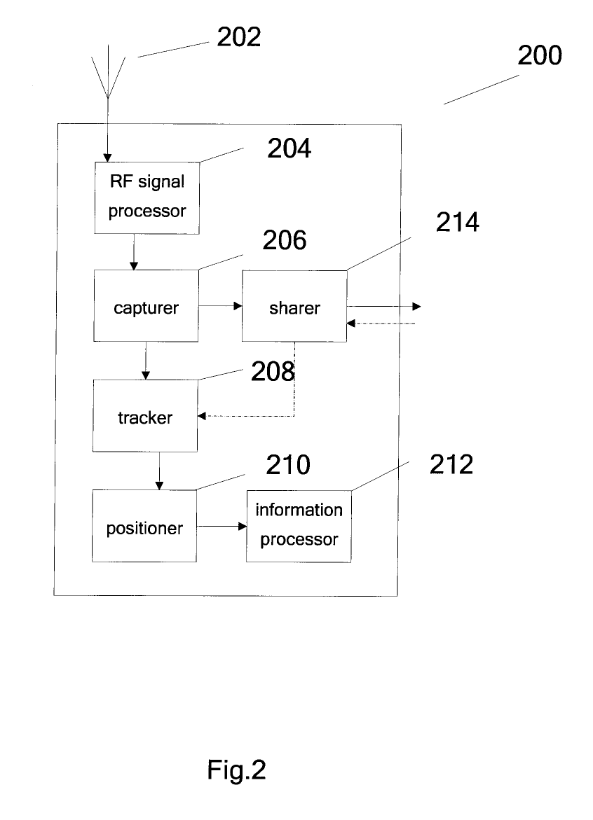

Referring to FIG. 2 below, a structural block diagram of a positioning device 200 of a satellite positioning system according to one embodiment of the present invention is shown. According to one embodiment of the present invention, a positioning device 200 for a satellite positioning system comprises: a RF signal processor 204 configured to perform processing on received RF signals transmitted by satellites to obtain corresponding IF signals, and feed the IF signals to a capturer; a capturer 206 configured to perform baseband processing on the received IF signals to capture parameters for tracking the satellites, and feed the parameters to a tracker 208 and a sharer 214; a tracker 208 configured to perform satellite tracking by utilizing the captured parameters for tracking the satellites; and a sharer 214 configured to share the captured parameters for tracking the satellites with another positioning device. In one or more embodiments, the antenna 202, RF signal processor 204, positioner 210 and information processor 212 may be similar to the corresponding components in the positioning device 100 of FIG. 1. Different from that device is the inclusion of a sharer 214, which is added in the positioning device 200. The sharer 214 is used to share the parameters for tracking the satellites with the other positioning device(s).

According to one or more aspects of the present invention, the sharing of the parameters for tracking the satellites with other positioning device comprises sending the captured parameters for tracking the satellites to the another positioning device. Specifically, according to an aspect of the present invention, the sharer 214 receives the parameters for tracking the satellites captured by the capturer 206, and sends the captured parameters for tracking the satellites to the other positioning device. According to one aspect of the present invention, the sharer 214 sends the captured parameters for tracking the satellites to the other positioning device through a short range wireless communication protocol such as Bluetooth, WiFi direct connection protocol, near field communication (NFC), or the like.

According to one or more embodiments of the present invention, the sharing of the parameters for tracking the satellites with the other positioning device further comprises receiving the parameters for tracking the satellites from the other positioning device. For instance, according to one aspect of the present invention, the sharer 214 further receives the parameters for tracking the satellites from the other positioning device, and the tracker 208 further utilizes the parameters for tracking the satellites received from the other positioning device to perform satellite tracking

According to embodiments of the present invention, for a Code Division Multiple Access (CDMA) satellite positioning system such as GPS, the parameters for tracking the satellites comprise a Code phase of satellite encoding and an IF corresponding to the satellite encoding. For a Frequency Division Multiple Access (FDMA) satellite positioning system such as GLONASS, the parameters for tracking the satellites comprise a communication carrier frequency of the satellite.

According to one or more embodiments of the present invention, a positioning device is capable of sharing the captured parameters for tracking the satellites, so that the other positioning device located nearby is enabled to receive the parameters for tracking the satellites therefrom to perform tracking of the satellites, which effectively solves the problems that existed in the art.

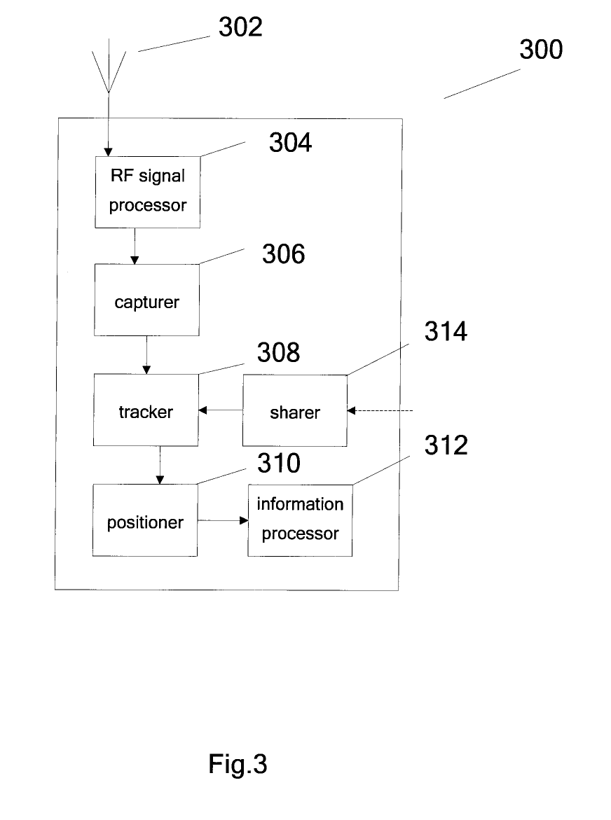

Referring to FIG. 3, a structural block diagram of a positioning device 300 of a satellite positioning system according to one or more other embodiments of the present invention is shown. According to one or more aspects of the present invention, the sharing of the parameters for tracking the satellites with the other positioning device comprises receiving the parameters for tracking the satellites from the other positioning device. By way of example, a positioning device 300 for a satellite positioning system may include: a RF signal processor 304 configured to perform processing on received RF signals transmitted by satellites to obtain corresponding IF signals, and feed the IF signals to a capturer; a capturer 306 configured to perform baseband processing on the received IF signals to capture parameters for tracking the satellites, and feed the parameters to a tracker 308; a sharer 314 configured to receive parameters for tracking the satellites from the other positioning device; and a tracker 308 configured to perform satellite tracking by utilizing the captured parameters for tracking the satellites and the parameters for tracking the satellites received from the other positioning device. In one or more embodiments, antenna 302, RF signal processor 304, positioner 310 and information processor 312 may be similar to the corresponding components in the positioning device 100 of FIG. 1. Different from that device is the provision of a sharer 314, which is added in the positioning device 300. The sharer 314 is configured to receive the parameters for tracking the satellites from the other positioning device and feed the parameters to the tracker 308, so that the tracker can perform satellite tracking by utilizing the captured parameters for tracking the satellites and the parameters for tracking the satellites received from the other positioning device. According to one or more embodiments of the present invention, the sharer 314 may receive the parameters for tracking the satellites from the other positioning device through a short range wireless communication protocol such as Bluetooth, WiFi direct connection protocol, near field communication (NFC), or the like.

According to certain embodiments of the present invention, for a Code Division Multiple Access (CDMA) satellite positioning system such as GPS, the parameters for tracking the satellites may include a Code phase of satellite encoding and an IF corresponding to the satellite encoding. For a Frequency Division Multiple Access (FDMA) satellite positioning system such as GLONASS, the parameters for tracking the satellites may include a communication carrier frequency of the satellite.

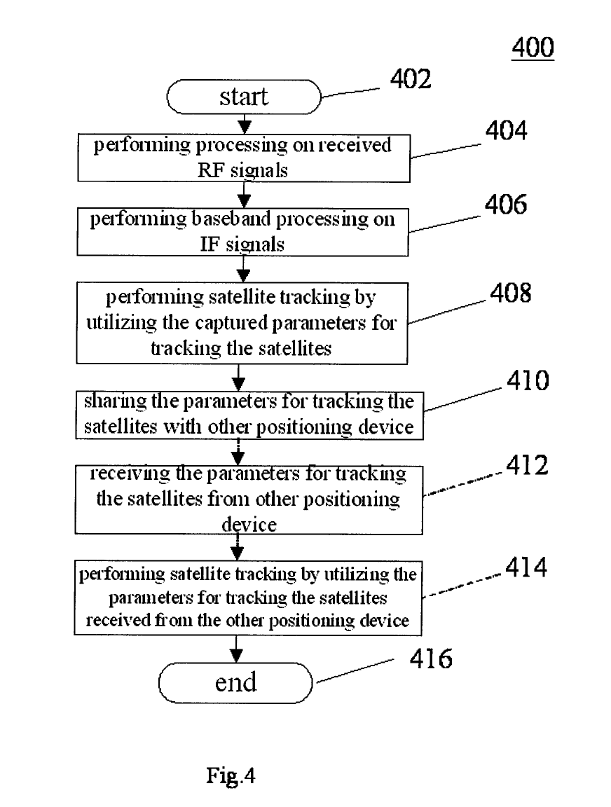

Referring to FIG. 4, a flowchart of a positioning method 400 for a satellite positioning system according to one or more embodiments of the present invention is shown. The positioning method 400 for a satellite positioning system starts from step 402, and the method 400 proceeds to step 404, to perform processing on received RF signals transmitted by satellites to obtain corresponding IF signals. Then, in the step 406, the method includes performing baseband processing on the IF signals to capture parameters for tracking the satellites. According to one or more embodiments of the present invention, for a Code Division Multiple Access (CDMA) satellite positioning system such as GPS, the parameters for tracking the satellites may comprise a Code phase of satellite encoding and an IF corresponding to the satellite encoding. For a Frequency Division Multiple Access (FDMA) satellite positioning system such as GLONASS, the parameters for tracking the satellites may comprise a communication carrier frequency of the satellite. Then, in step 408, the method includes performing satellite tracking by utilizing the captured parameters for tracking the satellites, and then, in step 410, sharing the parameters for tracking the satellites with other positioning device.

According to one or more embodiments of the present invention, the sharing of the parameters for tracking the satellites with the other positioning device may comprise sending the captured parameters for tracking the satellites to the other positioning device. According to certain embodiments of the present invention, the captured parameters may be sent to the other positioning device through a short range wireless communication protocol such as Bluetooth, WiFi direct connection protocol, near field communication (NFC), or the like. Thereafter, the method 400 proceeds to step 416 and ends.

According to one or more other embodiments of the present invention, the sharing of the parameters for tracking the satellites with other positioning device further comprises receiving the parameters for tracking the satellites from the other positioning device. Specifically, according to certain embodiments of the present invention, the method 400 further includes a step 412 of receiving the parameters for tracking the satellites from the other positioning device; and a step 414 of performing satellite tracking by utilizing the parameters for tracking the satellites received from the other positioning device.

According to one or more embodiments of the present invention, for a Code Division Multiple Access (CDMA) satellite positioning system such as GPS, the parameters for tracking the satellites may comprise a Code phase of satellite encoding and an IF corresponding to the satellite encoding. For a Frequency Division Multiple Access (FDMA) satellite positioning system such as GLONASS, the parameters for tracking the satellites may comprise a communication carrier frequency of the satellite.

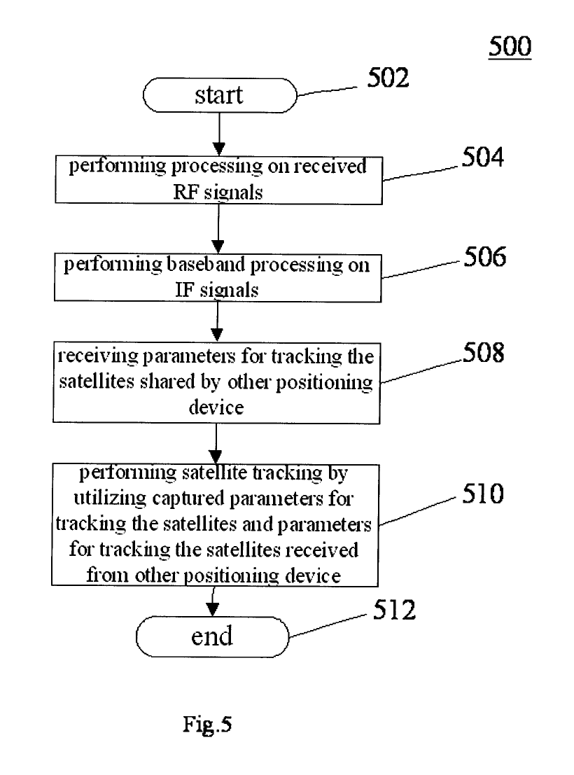

Referring to FIG. 5, a flowchart of a positioning method 500 for a satellite positioning system according to one or more other embodiments of the present invention is shown. According to another aspect of the present invention, the sharing of the parameters for tracking satellites with the other positioning device may comprise receiving the parameters for tracking the satellites from the other positioning device. The positioning method 500 for a satellite positioning system starts from step 502, and then, in step 504, the method includes performing processing on received RF signals transmitted by satellites to obtain corresponding IF signals; and in step 506, performing baseband processing on the IF signals to capture parameters for tracking the satellite; thereafter, in step 508, receiving the parameters for tracking the satellites from the other positioning device; then, in step 510, performing tracking by utilizing the captured parameters for tracking the satellites and the parameters for tracking the satellites received from the other positioning device. The method ends at step 512. According to one or more embodiments of the present invention, the sharer 214 may receive the parameters for tracking the satellites from the other positioning device through a short range wireless communication protocol such as Bluetooth, WiFi direct connection protocol, near field communication (NFC), or the like. Then, the method 400 proceeds to step 416 and ends.

According to certain embodiments of the present invention, for a Code Division Multiple Access (CDMA) satellite positioning system such as GPS, the parameters for tracking the satellites may comprise a Code phase of satellite encoding and an IF corresponding to the satellite encoding. For a Frequency Division Multiple Access (FDMA) satellite positioning system such as GLONASS, the parameters for tracking the satellites may comprise a communication carrier frequency of the satellite.

The present invention may be implemented as a positioning device or a positioning method. Corresponding to a positioning device implemented in software, the present invention may be implemented as a corresponding computer program product. The computer program product may include a computer readable storage medium having computer readable program instructions thereon for causing a processor to implement various aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A positioning device for a satellite positioning system, comprising:
a Radio Frequency (RF) signal processor configured to process received RF signals transmitted by satellites, to obtain corresponding Intermediate Frequency (IF) signals and feed the IF signals to a capturer;
a capturer configured to perform baseband processing on the received IF signals to capture parameters for tracking the satellites, and feed the parameters to a tracker and a sharer;
a tracker configured to perform satellite tracking by utilizing the captured parameters for tracking the satellites; and
a sharer configured to share the parameters for tracking the satellites with another positioning device.

2. The positioning device of claim 1, wherein:
the sharing of the parameters for tracking the satellites with the other positioning device comprises sending the captured parameters for tracking the satellites to the other positioning device.

3. The positioning device of claim 1, wherein:
the sharing of the parameters for tracking the satellites with the other positioning device comprises receiving parameters for tracking the satellites from the other positioning device.

4. The positioning device of claim 3, wherein:
the tracker is further configured to perform satellite tracking by utilizing the parameters for tracking the satellites received from the other positioning device.

5. The positioning device of claim 1, wherein:
the sharer shares the parameters for tracking the satellites with the other positioning device through a short range wireless communication protocol.

6. The positioning device of claim 1, wherein:
for a Code Division Multiple Access (CDMA) satellite positioning system, the parameters for tracking the satellites comprise a Code phase of satellite encoding and an IF corresponding to the satellite encoding;
for a Frequency Division Multiple Access (FDMA) satellite positioning system, the parameters for tracking the satellites comprise a communication carrier frequency of the satellite.

7. A positioning method for a positioning device of a satellite positioning system, comprising:
performing processing on received Radio Frequency (RF) signals transmitted by satellites to obtain corresponding Intermediate Frequency (IF) signals;
performing baseband processing on the IF signals to capture parameters for tracking the satellites;
performing satellite tracking by utilizing the captured parameters for tracking the satellites; and
sharing the parameters for tracking the satellites with another positioning device.

8. The method of claim 7, wherein:
the sharing of the parameters for tracking the satellites with the other positioning device comprises sending the captured parameters for tracking the satellites to the other positioning device.

9. The method of claim 7, wherein:
the sharing of the parameters for tracking the satellites with the other positioning device comprises receiving the parameters for tracking the satellites from the other positioning device.

10. The method of claim 9, further comprising:
performing satellite tracking by utilizing the parameters for tracking the satellites received from the other positioning device.

11. The method of claim 7, wherein:
the parameters for tracking the satellites is shared with the other positioning device through a short range wireless communication protocol.

12. The method of claim 7, wherein:
for a Code Division Multiple Access (CDMA) satellite positioning system, the parameters for tracking the satellites comprise a Code phase of satellite encoding and an IF corresponding to the satellite encoding;
for a Frequency Division Multiple Access (FDMA) satellite positioning system, the parameters for tracking the satellites comprise a communication carrier frequency of the satellite.

13. A computer program product for a positioning device of a satellite positioning system, the computer program product comprising:
a computer-readable storage medium having program instructions embodied therein, the program instructions being executable by a computer to cause the computer to:
perform processing on received Radio Frequency (RF) signals transmitted by satellites to obtain corresponding Intermediate Frequency (IF) signals;
perform baseband processing on the IF signals to capture parameters for tracking the satellites;
perform satellite tracking by utilizing the captured parameters for tracking the satellites; and
share the parameters for tracking the satellites with another positioning device.

14. The computer program product of claim 13, wherein:
the sharing of the parameters for tracking the satellites with the other positioning device comprises sending the captured parameters for tracking the satellites to the other positioning device.

15. The computer program product of claim 13, wherein:
the sharing of the parameters for tracking the satellites with the other positioning device comprises receiving the parameters for tracking the satellites from the other positioning device.

16. The computer program product of claim 15, further comprising:
performing satellite tracking by utilizing the parameters for tracking the satellites received from the other positioning device.

17. The computer program product of claim 13, wherein:
the parameters for tracking the satellites is shared with the other positioning device through a short range wireless communication protocol.

18. The computer program product of claim 13, wherein:
for a Code Division Multiple Access (CDMA) satellite positioning system, the parameters for tracking the satellites comprise a Code phase of satellite encoding and an IF corresponding to the satellite encoding;
for a Frequency Division Multiple Access (FDMA) satellite positioning system, the parameters for tracking the satellites comprise a communication carrier frequency of the satellite.
